(19) United States
(12) Patent Application Publication
(10) Pub. No.: US 2023/0029473 A1
(43) Pub. Date: Feb. 2, 2023

(54) RECONFIGURABLE SERIES-PARALLEL FUEL CELL POWER SYSTEM ENABLING OPTIMIZATION OF VEHICLE/AIRCRAFT SYSTEMS

(71) Applicant: HyFlyer Powertrain, LLC, Chandler, AZ (US)

(72) Inventors: Jesse Michael Schneider, Chandler, AZ (US); Liviu Ion Cosacescu, Burnaby (CA)

(21) Appl. No.: 17/874,919

(22) Filed: Jul. 27, 2022

Related U.S. Application Data
(60) Provisional application No. 63/226,035, filed on Jul. 27, 2021.

(51) Int. Cl. H01M 8/2465; H01M 8/04858; H01M 8/04955; H01M 8/04007; H01M 8/04225; H01M 8/04302

(52) U.S. Cl. CPC H01M 8/2465; H01M 8/0494; H01M 8/04955; H01M 8/04074; H01M 8/04225; H01M 8/04302; H01M 2250/20

(57) ABSTRACT

An electrical power system includes a first plurality of fuel cells connected to a positive voltage bus, a second plurality of fuel cells connected to a negative voltage bus, and a switching system configured to independently connect and disconnect a fuel cell in the first plurality of fuel cells with another fuel cell in the second plurality of fuel cells. Due to the series-parallel configuration aligned with the bus voltage, electrical power system may not require a DC-DC voltage convertor and thus allows elimination of a DC-DC voltage convertor from the electrical power system.

### CROSS-REFERENCE TO RELATED APPLICATION

This application claims benefit of priority to U.S. Application No. 63/226,035 filed on Jul. 27, 2021, the entire disclosure of which is hereby incorporated by reference.

### TECHNICAL FIELD OF THE INVENTION

The invention generally relates to a fuel cell based electrical power system that is applicable to mobile transport, such as automotive, heavy trucks, rail, marine, and particularly aerospace. The electrical power system may supply auxiliary power, main motive power, or a combination of the two.

### SUMMARY

According to one or more aspects of the present disclosure, an electrical power system includes a first plurality of fuel cells connected to a positive voltage bus, a second plurality of fuel cells connected to a negative voltage bus, and a switching system configured to independently connect and disconnect a fuel cell in the first plurality of fuel cells with another fuel cell in the second plurality of fuel cells. Due to the series-parallel configuration aligned with the bus voltage, electrical power system may not require a DC-DC voltage convertor and thus allows elimination of a DC-DC voltage convertor from the electrical power system.

In one or more embodiments of the electrical power system according to the previous paragraph, the electrical power system does not include a DC-DC voltage convertor.

In one or more embodiments of the electrical power system according to the any one of the previous paragraphs, the switching system includes a plurality of contactors controlled by an electronic controller.

In one or more embodiments of the electrical power system according to the any one of the previous paragraphs, the switching system is configured to form a first series circuit by connecting a first fuel cell in the first plurality of fuel cells to a second fuel cell in the second plurality of fuel cells and configured to form a second series circuit by connecting the third fuel cell in the first plurality of fuel cells to a fourth fuel cell in the second plurality of fuel cells and wherein the first series circuit is connected to the positive and negative bus in parallel with the second series circuit.

In one or more embodiments of the electrical power system according to the any one of the previous paragraphs, the switching system is configured to form a third series circuit between the positive and negative bus by connecting the first fuel cell to the fourth fuel cell or by connecting the second fuel cell to the third fuel cell while disconnecting the first fuel cell from the second fuel cell and disconnecting the third fuel cell from the fourth fuel cell.

In one or more embodiments of the electrical power system according to the any one of the previous paragraphs, the switching system is configured to form a circuit having one fuel cell from the first plurality of fuel cells connected in series to a parallel circuit having two fuel cells from the second plurality of fuel cells or one fuel cell from the second plurality of fuel cells connected in series to a parallel circuit having two fuel cells from the first plurality of fuel cells.

In one or more embodiments of the electrical power system according to the any one of the previous paragraphs, the system further includes a DC-DC converter. The switching system is configured to interconnect the DC-DC convertor in series with a first fuel cell in the first plurality or a second fuel cell in the second plurality of fuel cells.

In one or more embodiments of the electrical power system according to the any one of the previous paragraphs, the system further includes a battery. The system also includes a second switching system independent and distinct from the switching system. The second switching system is configured to connect and disconnect the battery with the positive and negative bus.

In one or more embodiments of the electrical power system according to the any one of the previous paragraphs, the system further includes a cooling system configured to cool the first and second plurality of fuel cells. The cooling system is configured to disconnect a coolant flow from a fuel cell in the first or second plurality of fuel cells when it is disconnected from the positive or negative voltage bus and correspondingly increase a coolant flow rate through the remaining fuel cells, thereby providing additional cooling to the remaining fuel cells.

In one or more embodiments of the electrical power system according to the any one of the previous paragraphs, the system further includes a radiator that is configured to provide a propulsive force due to expansion of air from the heat released by the radiator.

In one or more embodiments of the electrical power system according to the any one of the previous paragraphs, a heat exchanger of the cooling system is incorporated into outer walls of the vehicle.

In one or more embodiments of the electrical power system according to the any one of the previous paragraphs, the cooling system is configured to provide heat from the fuel cell to a vehicle cabin.

In one or more embodiments of the electrical power system according to the any one of the previous paragraphs, a heat exchanger of the cooling system is incorporated into walls of the vehicle cabin.

In one or more embodiments of the electrical power system according to the any one of the previous paragraphs, the cooling system is configured to be heated by an external power source prior to a fuel cell in the first plurality of fuel cells or the second plurality of fuel cells entering in a startup mode.

In one or more embodiments of the electrical power system according to the any one of the previous paragraphs, only one fuel cell in the first plurality of fuel cells or the second plurality of fuel cells is in a startup mode at one time.

### BRIEF DESCRIPTION OF THE DRAWINGS

The present invention will now be described, by way of example with reference to the accompanying drawings, in which:

FIG. 1 is a schematic view of an electrical power system having fuel cells connected by a switching system into two series circuits that are connected in parallel to a voltage bus according to some embodiments;

FIG. 2 is schematic view of the electrical power system of FIG. 1 having fuel cells connected by a switching system into a single series circuit according to some embodiments;

FIG. 3 is schematic diagram of the electrical power system of FIG. 1 having one fuel cell connected by a switching system in series to a parallel configuration of fuel cells according to some embodiments;

FIG. 4 is a schematic view of an electrical power system having one series circuit containing two fuel cells connected by a switching system in parallel to a voltage bus to another services circuit containing a DC-DC convertor and a fuel cell according to some embodiments; and

FIG. 5 is a schematic view of an electrical power system having a battery connected by a switching system in parallel with fuel cells connected by the switching system into two series circuits that are connected in parallel to a voltage bus according to some embodiments.

### DETAILED DESCRIPTION

This patent application describes a fuel cell-based electrical power system that is usable for powering mobile transports, such as automotive, heavy trucks, rail, marine, and particularly aerospace applications. The electrical power system may supply auxiliary power, main motive power, or a combination of the two.

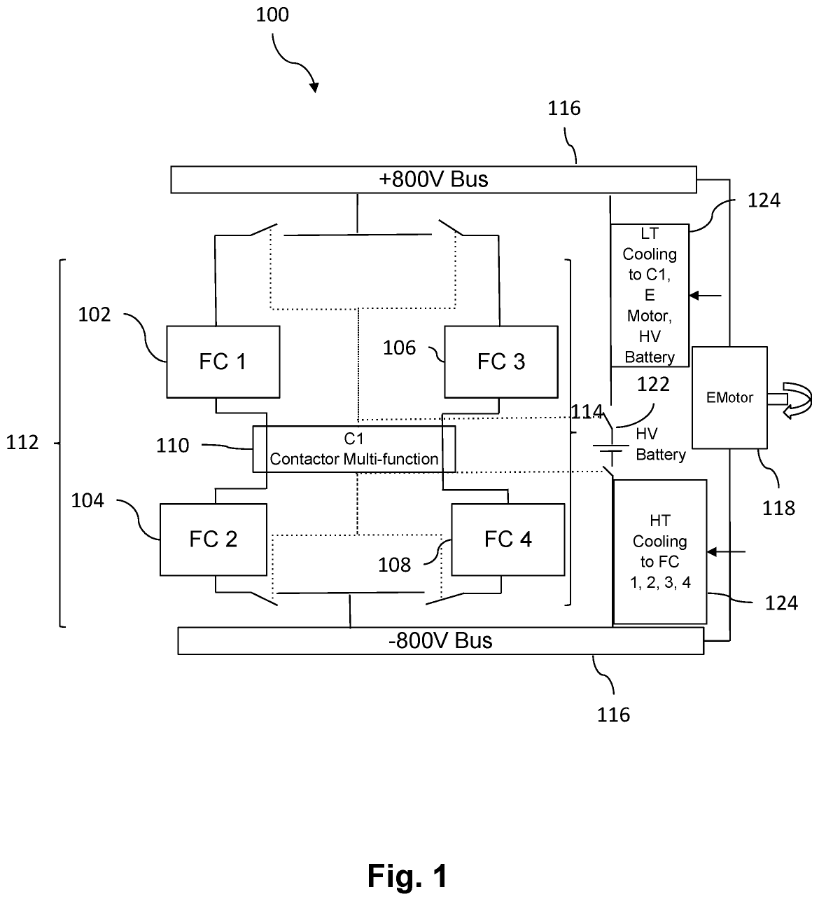

The electrical power system 100 contains a plurality of fuel cells, 102, 104, 106, 108 and a switching system 110, e.g., a plurality of contactors under the control of an electronic controller, that allows the fuel cells 102, 104, 106, 108 to be configured as at least two parallel series circuits 112, 114, each containing at least two fuel cells 102, 104 or 106, 108 connected in series with each other and to a power bus 116 as illustrated in FIG. 1. The power bus 116 may be connected to an electric motor 118 which provides motive power for a vehicle, e.g., car, truck, train, ship, or airplane. In the illustrated example, the electrical power system 100 is configured to provide 600 kilowatts of DC power at 800 volts. A first series circuit 112 that is connected to the power bus 116 contains two fuel cells 102 and 104 and a second series circuit 114 that is connected to the power bus 116 in parallel with the first series circuit 112 contains two fuel cells 106 and 108. Each fuel cell 102, 104, 106, 108 is configured to provide 750 amperes at 400 volts, when the four fuel cells 102, 104, 106, 108 are connected in the two parallel series circuits 112, 114, the electrical power system 100 produces the 600 kW of electrical power.

In nearly all applications, but especially in aerospace applications, maximizing the power-to-weight ratio of the electrical power system 100 is crucial. The high voltage of this electrical power system 100 allows smaller cross section conductors to be used in the transmission lines and electric motors, thereby reducing weight, material costs, and resistive losses of the lines and motors due to having a lower operating current than in a system with the same power rating having a lower operating voltage.

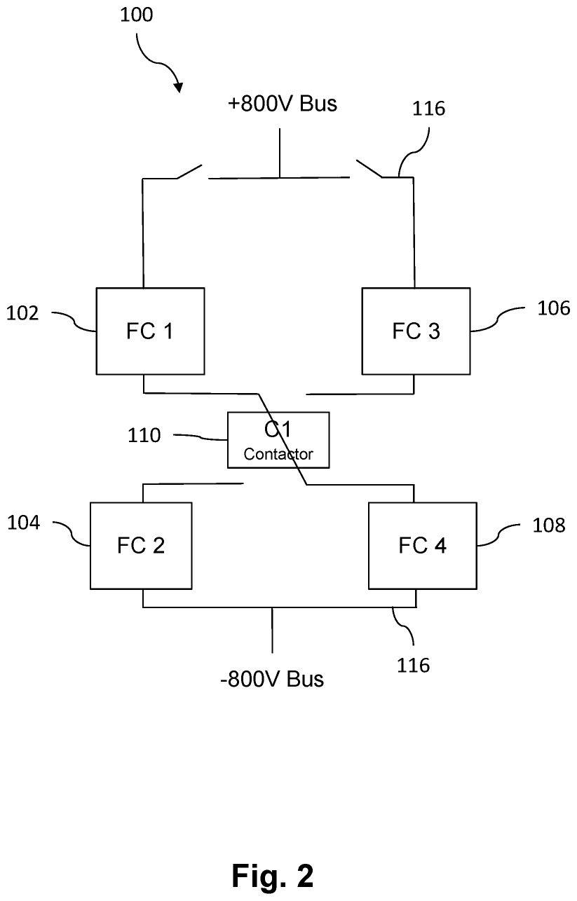

The switching system 110 also allows the fuel cells 102, 104, 106, 108 to be reconfigured into other configurations, such as a single lower power single series circuit shown in FIG. 2 by disconnecting one of the fuel cell 104, 106 in each of the two series circuits 112, 114 and reconnecting the remaining fuel cells 102, 108 in each of the two series circuits 112, 114 into the single series circuit. The electrical power system 100 in the reconfiguration of FIG. 2 will provide half of the power provided by the configuration of FIG. 1. This reconfiguration may be made by the electronic controller in order to remove a defective fuel cell, e.g., 104 from service if the controller detects a fault in one or more of the fuel cells. If a single fuel cell fails, that fuel cell plus another fuel cell in the other series circuit must be removed from service in order to maintain the power bus voltage.

This reconfiguration shown in FIG. 2 may alternatively be done by the electronic controller to reduce output of the electrical power system to response to a reduced power output requirement, e.g., providing cruising power vs. take-off power. This reconfiguration of the fuel cells can also increase the capacity of the cooling system since the thermal mass of the cooling system is now absorbing less heat from the fuel cells. Of course, the controller may also reconfigure the electrical power system by disconnecting one or the other of the series circuits 112, 114 and allowing only a single fuel cell string to operate.

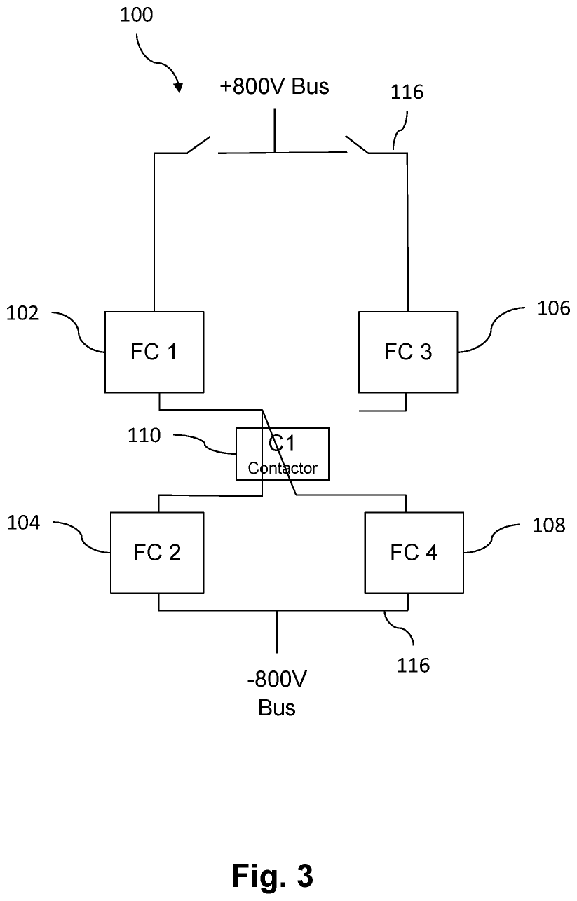

FIG. 3 shows an alternative reconfiguration of the electrical power system in which the switching system 110 disconnects one of the fuel cell, e.g., 106, due to the electronic controller determining a fault in that fuel cell 106 and reconnects one fuel cell 102 connected in series with a parallel configuration of the other remaining fuel cells 104, 108 fuel cells.

The series-parallel configuration of the electrical power system 100 presented in FIGS. 1, 2, and 3 is aligned with the bus voltage and provides the benefit of eliminating the need to regulate the DC voltage of the power bus using a DC-DC voltage convertor, thereby possibly eliminating the need for a DC-DC voltage convertor in the electrical power system 100. This reduces the total weight of the electrical power system weight and reduces component cost. The elimination of the DC-DC voltage converter also reduces parasitic power losses from the electrical power system 100 caused by a DC-DC voltage convertor and additionally reduces the thermal load on the cooling system since cooling no longer needs to be provided to a DC-DC voltage convertor. The electrical power system 100 also provides robustness and redundancy via the two parallel series connected circuits. 112, 114 because the electrical power system 100 is able to operate, at lower power output, if one or more fuel cells fail.

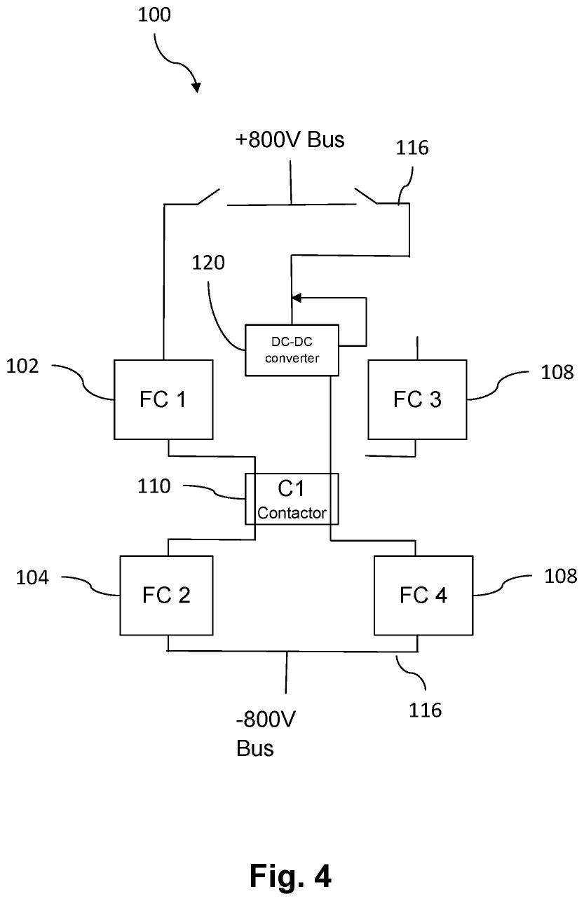

In another embodiment shown in FIG. 4, the electrical power system includes a DC-DC convertor 120 and the switching system 110 is configured to connect the DC-DC convertor into one of the series circuits 112, 114 in place of any one of the fuel cells 102, 104, 106, 108 to remove a defective fuel cell from service or to reduce the power output of the electrical power system. In the illustrated example, the switching system has disconnected the fuel cell 106 and connected the DC-DC convertor 120 in its place so that the series circuit 114 matches the voltage of the series circuit 112. The reconfiguration of the electrical power system as shown in FIG. 3 has the benefit of providing more power than the reconfiguration of the electrical power system 100 shown in FIG. 2. However, it will provide less power than the configuration of FIG. 1. It also has increased component cost, system weight, and cooling system capacity than the reconfiguration of the electrical power system 100 shown in FIG. 2.

As illustrated in FIG. 1 electrical power system 100 may also include a battery 122 that may be connected in parallel with the fuel cells by the switching system 110 to provide additional power as needed, e.g., for takeoff or emergency back-up power in the case of failure of more than two of the fuel cells. The electrical power system 100 may include a separate secondary switching system to connect the battery to the power bus to provide robust electrical power in case of an emergency resulting from the failure of the primary switching system 110.

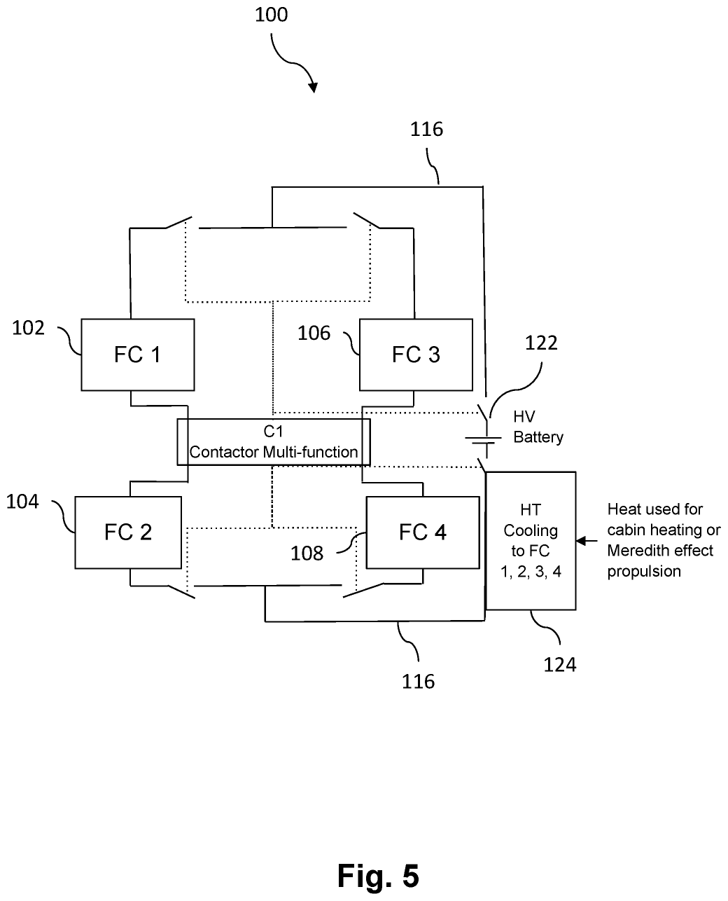

The electrical power system 100 illustrated in FIG. 5 includes a cooling system 124 designed to carry waste heat away from the fuel cells 102, 104, 106, 108. This waste heat may be used to provide heat to a vehicle cabin. The cooling system 124 may alternatively or in addition include an external radiator that is configured to provide additional thrust for an aircraft or other vehicle via the Meredith effect. The cooling system 124 may be configured to disconnect a coolant flow from a nonfunctioning fuel cell and correspondingly increase a coolant flow rate through the remaining fuel cells, thereby providing additional cooling to the remaining fuel cells. The cooling system 124 may also be heated by an external power source to assist and shorten the duration of the startup process of the fuel cells. As illustrated in FIG. 1, the cooling system 124 may also may a separate cooling loop configured to cool other components, such as the electric motor, the battery, the switching system, and/or the DC-DC convertor which operate at a lower temperature than the fuel cells.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical power system, comprising:
a first plurality of fuel cells connected to a positive voltage bus;
a second plurality of fuel cells connected to a negative voltage bus; and
a switching system configured to independently connect and disconnect a fuel cell in the first plurality of fuel cells with another fuel cell in the second plurality of fuel cells.

2. The electrical power system according to claim 1, wherein the electrical power system does not comprise a DC-DC voltage convertor.

3. The electrical power system according to claim 1, wherein the switching system includes a plurality of contactors controlled by an electronic controller.

4. The electrical power system according to claim 1, wherein the switching system is configured to form a first series circuit by connecting a first fuel cell in the first plurality of fuel cells to a second fuel cell in the second plurality of fuel cells and configured to form a second series circuit by connecting a third fuel cell in the first plurality of fuel cells to a fourth fuel cell in the second plurality of fuel cells and wherein the first series circuit is connected to the positive and negative bus in parallel with the second series circuit.

5. The electrical power system according to claim 4, wherein the switching system is configured to form a third series circuit between the positive and negative bus by connecting the first fuel cell to the fourth fuel cell or by connecting the second fuel cell to the third fuel cell while disconnecting the first fuel cell from the second fuel cell and disconnecting the third fuel cell from the fourth fuel cell.

6. The electrical power system according to claim 1, wherein the switching system is configured to form a circuit having one fuel cell from the first plurality of fuel cells connected in series to a parallel circuit having two fuel cells from the second plurality of fuel cells or one fuel cell from the second plurality of fuel cells connected in series to a parallel circuit having two fuel cells from the first plurality of fuel cells.

7. The electrical power system according to claim 1, wherein the system further comprises a DC-DC converter and wherein the switching system is configured to interconnect the DC-DC converter in series with a first fuel cell in the first plurality or a second fuel cell in the second plurality of fuel cells.

8. The electrical power system according to claim 1, wherein the system further comprises a battery and wherein the system further comprises a second switching system independent and distinct from the switching system and configured to connect and disconnect the battery with the positive and negative bus.

9. The electrical power system according to claim 1, wherein the system further comprises a cooling system configured to cool the first and second plurality of fuel cells, wherein the cooling system is configured to disconnect a coolant flow from a fuel cell in the first or second plurality of fuel cells when it is disconnected from the positive or negative voltage bus and correspondingly increase a coolant flow rate through the remaining fuel cells, thereby providing additional cooling to the remaining fuel cells.

10. The electrical power system according to claim 9, wherein the cooling system includes a radiator that is configured to provide a propulsive force due to expansion of air from heat released by the radiator.

11. The electrical power system according to claim 9, wherein a heat exchanger of the cooling system is incorporated into outer walls of a vehicle.

12. The electrical power system according to claim 9, wherein the cooling system is configured to provide heat from the fuel cell to a vehicle cabin.

13. The electrical power system according to claim 12, wherein a heat exchanger of the cooling system is incorporated into walls of the vehicle cabin.

14. The electrical power system according to claim 9, wherein the cooling system is configured to be heated by an external power source prior to a fuel cell in the first plurality of fuel cells or the second plurality of fuel cells entering in a startup mode.

15. The electrical power system according to claim 1, wherein only one fuel cell in the first plurality of fuel cells or the second plurality of fuel cells is in a startup mode at one time.
